(19) United States
(12) Patent Application Publication
(10) Pub. No.: US 2026/0300489 A1
(43) Pub. Date: Oct. 1, 2026

(54) DYNAMIC HARDWARE AWARE MODEL PARTITIONING

(71) Applicant: Microsoft Technology Licensing, LLC, Redmond, WA (US)

(72) Inventor: Aditya Vasanth CHALLAPALLY, San Francisco, CA (US)

(73) Assignee: Microsoft Technology Licensing, LLC, Redmond, WA (US)

(21) Appl. No.: 19/089,629

(22) Filed: Mar. 25, 2025

(51) Int. Cl. G06F 21/57; G06N 3/10

(52) U.S. Cl. CPC G06F 21/57; G06N 3/105; G06F 2221/034

(57) ABSTRACT

A data processing system implements a model partitioning framework that partitions the layers of a neural network of an AI model into multiple partitions. Each partition includes a subset of the layers of the neural network architecture and each partition has different security requirements based on whether the layers in the partition are receiving sensitive input data or operating on data from which features of the sensitive input data can be reconstructed. The model partitioning framework determines the security requirements of each of the layers of the neural network architecture and partitioning the neural network architecture into multiple partitions based on the security requirements of the layers included in each partition and the security features of the hardware security domains available for operating each of the partitions. Each partition is operated in a hardware security domain that satisfies the security requirements of that respective partition.

### BACKGROUND

Modern neural networks processing sensitive data present significant security challenges for organizations deploying artificial intelligence (AI) systems. Current approaches require either running entire neural networks in secure hardware environments, which drastically impacts performance and cost, or risking sensitive data exposure by processing everything in standard hardware. The manual process of analyzing neural network architectures to determine security requirements is complex and prone to errors, particularly given the intricate ways different types of layers process and preserve information.

### SUMMARY

An example data processing system according to the disclosure includes a processor and a memory storing executable instructions. The instructions when executed cause the processor alone or in combination with other processors to perform operations including analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing connections between the layers of the neural network architecture that facilitate information flowing between the layers, and dependency information representing relationships between layers in which an output of one layer is provided as an input to another layer; obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data; determining security requirements for each of the layers of the neural network architecture based on the map of the layers of the neural network architecture by analyzing the map to determine a position of each of the layers relative to an input layer of the neural network architecture and a layer type associated with each of the layers; determining which hardware components can satisfy the security requirements for each of the layers of the neural network architecture; partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and operating the partitioned neural network architecture on the selected hardware components.

An example method implemented in a data processing system includes analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing connections between the layers of the neural network architecture that facilitate information flowing between the layers, and dependency information representing relationships between layers in which an output of one layer is provided as an input to another layer; obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data; determining security requirements for each of the layers of the neural network architecture based on the map of the layers of the neural network architecture by analyzing the map to determine a position of each of the layers relative to an input layer of the neural network architecture and a layer type associated with each of the layers; determining which hardware components can satisfy the security requirements for each of the layers of the neural network architecture; partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and operating the partitioned neural network architecture on the selected hardware components.

An example machine-readable medium on which are stored instructions that, when executed, cause a processor of alone or in combination with other processors to perform operations of analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing connections between the layers of the neural network architecture that facilitate information flowing between the layers, and dependency information representing relationships between layers in which an output of one layer is provided as an input to another layer; obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data; determining security requirements for each of the layers of the neural network architecture based on the map of the layers of the neural network architecture by analyzing the map to determine a position of each of the layers relative to an input layer of the neural network architecture and a layer type associated with each of the layers; determining which hardware components can satisfy the security requirements for each of the layers of the neural network architecture; partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and operating the partitioned neural network architecture on the selected hardware components.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram showing multiple layers of a neural network of an AI model.

FIG. 1B is a diagram showing an example computing environment 111 divided into three security zones that each provide different levels of security to the data and processed executed therein.

FIG. 1C is a diagram showing the layers of the neural network of the AI model show in FIG. 1A having been partitioned according to the security requirements of the layers of the AI model according to the techniques disclosed herein.

FIG. 1D is a diagram showing an example of the partitions of the portioned neural network shown in FIG. 1C being implemented in different security zones of the

FIG. 2 is a diagram an example model partitioning framework that can partition a neural network model according to the techniques disclosed herein.

FIG. 3 is a diagram of a neural network architecture mapping unit of the model partitioning framework shown in FIG. 2.

FIG. 4 is a diagram of an example domain transition source unit and a domain transition receiver unit for establishing a secure communication channel between partitions of a partitioned neural network.

FIG. 5 is a diagram of an example run-time partitioning framework according to the techniques disclosed herein.

FIG. 6 is a diagram of an example computing environment in which the techniques for dynamically partitioning neural networks of AI models is implemented.

FIG. 7 is a flow chart of an example process for hydrating prompts for a large language model according to the techniques disclosed herein.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

### DETAILED DESCRIPTION

Systems and methods for dynamic hardware aware model partitioning are provided. These techniques implement a model partitioning framework that partitions the layers of a neural network architecture of an AI model into multiple partitions. Each partition includes a subset of the layers of the neural network architecture and each partition has different security requirements based on whether the layers in the partition are receiving sensitive input data or operating on data from which features of the sensitive input data can be reconstructed. An attacker could potentially obtain or recover features of this sensitive input data by compromising the security of one of these layers of the model. Current solutions to this technical problem include operating the entire model in a secure computing environment to prevent unauthorized access or tampering with the data or the model. However, this approach is not only costly but can also significantly impact the performance of the model due to various bottlenecks in operating the model in such a secure computing environment.

The model partitioning framework disclosed herein provides a technical solution to this and other problems with operating an AI model in a secure computing environment by partitioning the neural network architecture of the model into multiple partitions based in part on the security requirements of each of the layers and the availability of hardware security domains that provide security features that satisfy the security requirements of the layers included each of the partitions.

Security features, as used herein refers to physical components and/or measures taken to protect the data being processed by the computing hardware of the hardware security domain from unauthorized access, tampering, and/or other security threats. Security features can also include software-based security features that implement mechanisms for protecting software and data in the hardware security domain from unauthorized access, tampering, and/or other security threats.

The model partitioning framework analyzes and maps the layers of the neural network architecture of the AI model, determines the characteristics of each of the layers of the neural network architecture, and identifies data that is input into, operated on by the layer, and/or output from each layer of the neural network. Based on this information, the model partitioning framework determines the security requirements of each of the layers of the neural network architecture.

Security requirements, as used herein, provide an indication of how sensitive the data that a particular layer receives as an input, generates as intermediate data, and/or generates as an output of the layer. The model partitioning framework determines a layer sensitivity score for each of the layers of the neural network architecture. A higher layer sensitivity score indicates that the layer operates on sensitive input information and/or on data from which features of the sensitive input information can be reconstructed. A lower layer sensitivity score indicates that the layer operates on abstract feature information from which reconstruction of the features of the secure input data is computationally infeasible.

The model partitioning framework identifies hardware security domains that are available for executing partitions of the neural network architecture. Each hardware security domain is a computing environment in which computing resources for executing a partition of the neural network architecture can be allocated. Each hardware security domain is associated with computing resources that provide different sets of security features that prevent unauthorized access to or tampering with sensitive data and/or the partitions of the neural network architecture implemented therein. The model partitioning framework partitions the layers of the neural network architecture into partitions that include one or more layers of the neural network architecture based on the security requirements of the layers and the security features provided by the hardware security domains available for operating the partitions. A technical benefit of this approach is that partitions of the neural network architecture of an AI model can be implemented in hardware security domains that provide security features that satisfy the security requirements of those partitions, while other partitions that do not operate on sensitive input data or on data from which features of the sensitive input data could be reconstructed can be implemented in less hardware security domains that provide fewer security features since the risk of sensitive data being leaked has been mitigated. Consequently, the model partitioning framework facilitates more efficient allocation of computing resources to support the AI model. The model partitioning framework can indicate that only those partitions that require certain security features to be implemented in secure computing environments. Consequently, the cost and bottlenecks associated with such secure computing environments can be reduced, and the overall efficiency of the model can be improved by reducing latency associated with implementing the AI model entirely within a secure computing environment. The model partitioning framework provides a technical solution to these and other technical problems associated with execution of an AI model in a secure hardware environment.

A run-time partitioning framework is also provided that facilitates deploying the partitions of the partitioned neural network architecture to appropriate hardware security domains and facilitates secure communications between the partitions operating in different hardware security domains. A technical benefit of this approach is that the potentially sensitive data is protected from unauthorized access and/or tampering as the data is transmitted from one partition to another. Consequently, the run-time partitioning framework thwarts numerous types of attacks attempting to access the sensitive data and/or alter the behavior of the model. For example, the run-time partitioning framework can thwart memory extraction attacks, in which an attack with access to the Graphics Processing Unit (GPU) memory attempts to reconstruct source images by capturing activation tensors from the early convolution layers. The run-time partitioning framework thwarts such attacks by operating sensitive layers of the neural network architecture, such at the input layers, in a hardware security domain identified by the model partitioning framework that prevents such unauthorized access or tampering with the model. The un-time partitioning framework can also prevent model inversion attacks in which an attacker exploits gradient information during inference to reconstruct sensitive input data. The run-time partitioning framework thwarts such attacks by ensuring that layers operating on such sensitive input information, or intermediate data from which sensitive information can be reconstructed, in a hardware security domain that prevents such unauthorized access. Other layers that operate on abstract features from which the sensitive input information cannot or is unlikely to be recovered can operate in a hardware security domain that is less secure than the hardware security domain in which layers of the neural network that operate on sensitive data. The run-time partitioning framework also protects against side channel attacks, which are timing attacks in which an attacker attempts to infer input characteristics by measuring layer computation times. The model partitioning framework forces sensitive computation timing to be constant within the secure hardware domains, while allowing variable timing for abstract feature processing in standard hardware in less secure hardware domains. The run-time partitioning framework can also thwart feature map analysis attacks in which an attacker access intermediate layer outputs to analyze feature maps to extract sensitive patterns. The run-time partitioning framework ensures that feature maps containing recognizable input patterns remain in a secure hardware domain while highly transformed feature representations can be released to a partition of the neural network that is operating in a less secure hardware domain since an attacker cannot recover the sensitive input information from the highly transformed feature representations. These and other technical benefits of the techniques disclosed herein will be evident from the discussion of the example implementations that follow.

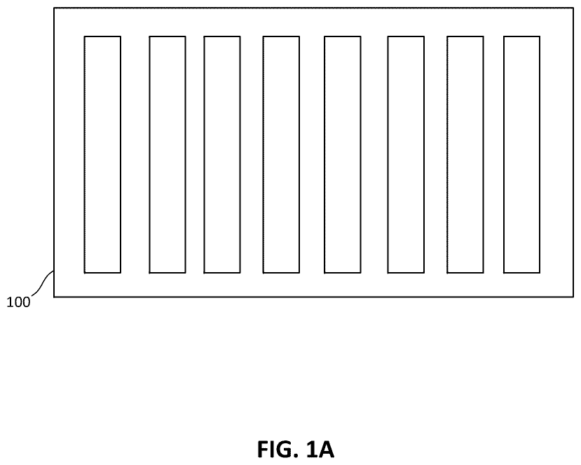

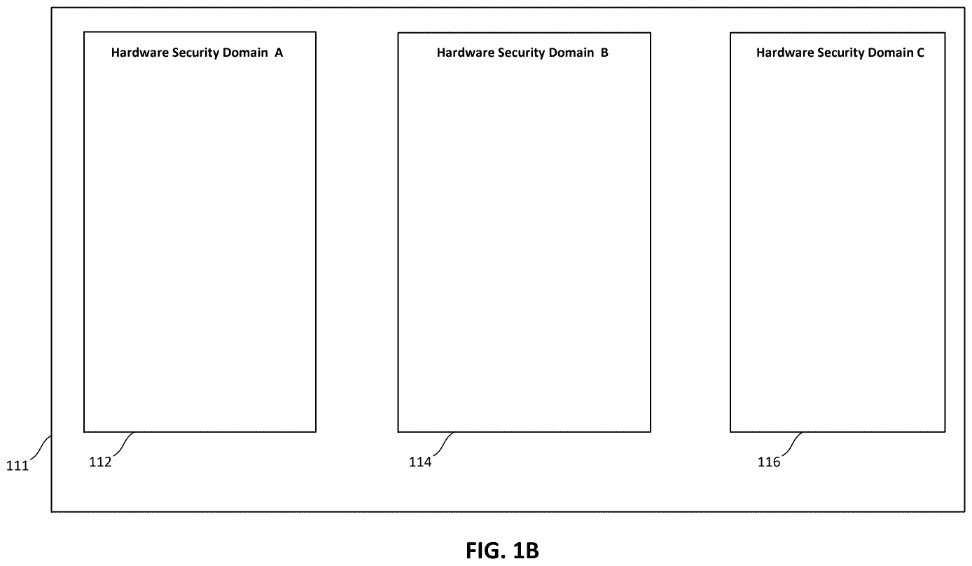

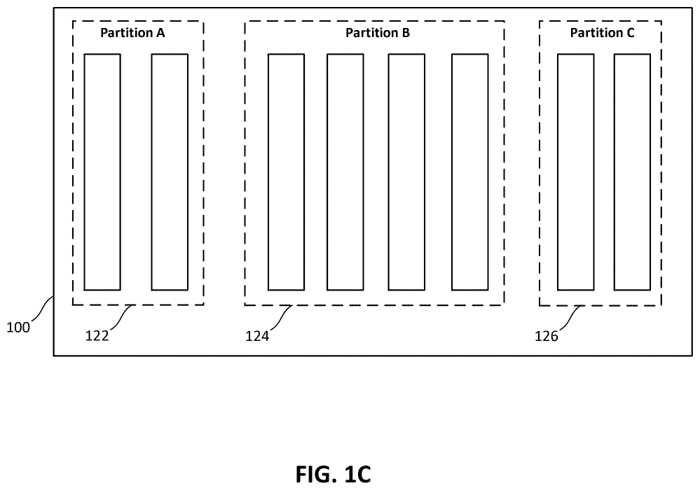

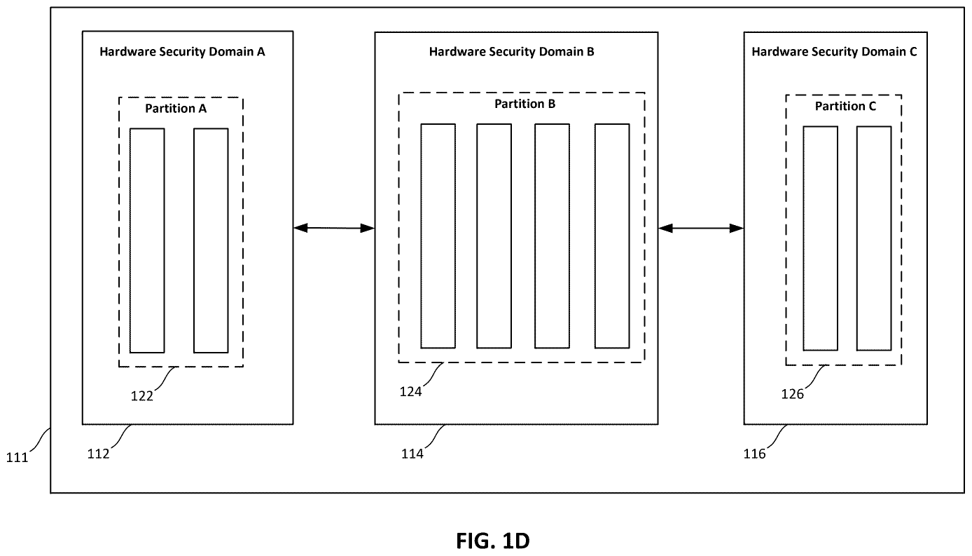

FIG. 1A is a diagram showing multiple layers of a neural network architecture of an AI model 100. The model includes a plurality of layers. The number of layers included in the neural network and the types of layers that are included in the network can vary in different implementations of the AI model 100. The layers may include one or more input layers that are configured to receive one or more inputs, such as but not limited to textual content, images, video, numerical values, and/or other types of inputs to be analyzed by the model. The input layers can receive and process sensitive input data that requires these layers to be operated in a more secure computing environment than other layers which deal with data that has been transformed into more abstract features that resist reconstruction of the features of the original sensitive input data. The input layer or layers are configured to receive raw input data and to provide the data to one or more intermediate layers of the neural network that process and transform the input data. The intermediate layers can perform complex computations and/or feature extraction on the input data. The intermediate layers may be operated in a computing environment that provides fewer security features than the input layers, because the intermediate layers transform the sensitive input data into intermediate data. The layers may also include one or more output layers that produces the output of the AI model 100. The output layer or output layers may implement an activation function, such as but not limited to SoftMax or a sigmoid function to transform that data received from the one or more intermediate layers into an interpretable result. The output layers may operate on data that has been significantly transformed from the input data and the original input data may not be reconstructed from this data. Therefore, the output layer or layers may be operated in a less secure computing environment than the input layers and/or the intermediate layers. This example is intended to illustrate at a high level how the layers of a neural network of an AI model may have different security requirements. Additional features of the layers can contribute to the complexity of architecture of the neural network and complicate the security requirements of the various layers of the model. Additional details and examples of such features are discussed in greater detail with respect to the various example implementations which follow.

FIG. 1B is a diagram showing an example computing environment 111 divided into three hardware security domains, hardware security domain 112, hardware security domain 114, and hardware security domain 116 which each provide different levels of security to the data and processed executed therein. The model partitioning framework accesses hardware configuration information that includes information identifying the computing resources that are available for operating the partitions of the neural network of the AI model 100. The model partitioning framework analyzes the hardware configuration information and creates a hierarchy of the search domains optimize for neural network operations. Each of the hardware security domains are implemented on separate servers or sets of servers in some implementations. In other implementations, one or more of the hardware security domains are implemented on the same server or set of servers, but the processes and data implemented within each hardware security domain are isolated from other hardware security domains to prevent unauthorized access or tampering with the data or the model by unauthorized users or by processes operating in a different hardware security domain. As discussed in greater detail in the examples which follow, the model partitioning framework provides secure, encrypted communication channels between partitions implemented in different hardware security domains to ensure that sensitive information is not disclosed when data is exchanged between layers of the neural network that are implemented in different hardware security domains.

Each of the domains may have various hardware components that provide varying levels of security for supporting the operation of layers of the neural network. For instance, a hardware security domain may include secure machine learning accelerators, which are hardware that are specifically designed to accelerate tasks associated with AI models and incorporate security features that protect sensitive data and model components from unauthorized access and/or attacks. The secure machine learning accelerator may implement a trusted execution environment (TEE) that provides a secure computing environment in which sensitive program code of the model can be executed and in which the model and the data utilized by the model are isolated from other less secure computing environments. The secure machine learning accelerator protects sensitive data being processed, prevent attacks that are intended to steal or comprise this secure data, and ensure the integrity of the components of the AI model being executed within the secure environment A hardware security domain may implement a hardware security module (HSM), which is a tamper-resistant hardware device that securely manages and stores cryptographic keys. The HSM enables secure cryptographic operations and protects sensitive data by isolating cryptographic keys and operations utilizing these keys from unauthorized access or tampering. Yet another hardware security domain may include regular computing domain, which may provide at least some security features, but in which other processes and services not specifically related to the AI model may also be implemented. The regular computing domain may be utilized to implement partitions of the neural network that operate on data that has sufficiently transformed into more abstract features that resist reconstruction of the original sensitive input data that these partitions can be implemented in a computing environment that provides less security features.

FIG. 1C is a diagram showing the layers of the neural network of the AI model 100 show in FIG. 1A having been partitioned by the model partitioning framework according to the security requirements of the layers of the AI model 100 and the hardware security domains shown in FIG. 1B. In this example, the neural network has been partitioned into three partitions: partition 122, partition 124, and partition 126. Each of these partitions have distinct security requirements that are determined using the model partitioning framework provided herein and correspond to hardware security domains that are shown in FIG. 1B. Additional details of how the model partitioning framework determines these partitions is provided in the examples which follow. Each of the partitions may be implemented in computing hardware that is capable of satisfying the specific security requirements associated with the layers in that partition. The layers in one partition can communicate with layers in another partition using secure communications channels that utilize domain-specific encryption protocols. These secure communications channels include integrity verification and domain-specific key generation to prevent key attacks and unauthorized data access. Additional details of these secure communications channels are provided in the examples which follow.

FIG. 1D is a diagram showing an example of the partitions of the portioned neural network shown in FIG. 1B being associated with different hardware security domains of the computing environment 111. The model partitioning framework operates the partition 122, the partition 124, and the partition 126 identified by the model partitioning framework in FIG. 1B in hardware security domain 112, hardware security domain 114, and hardware security domain 116, respectively, based on the security requirements of each of the partitions and the security features associated with the hardware security domains. As discussed in the examples which follow, the partitions are determined based on the hardware security domains that are available for operating at least a portion of the layers of the neural network of the AI model 100.

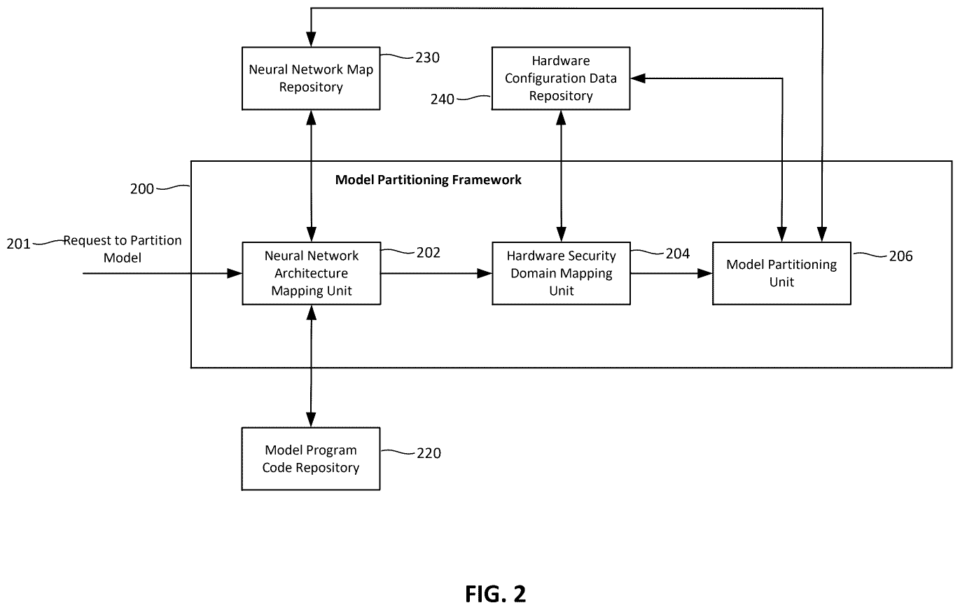

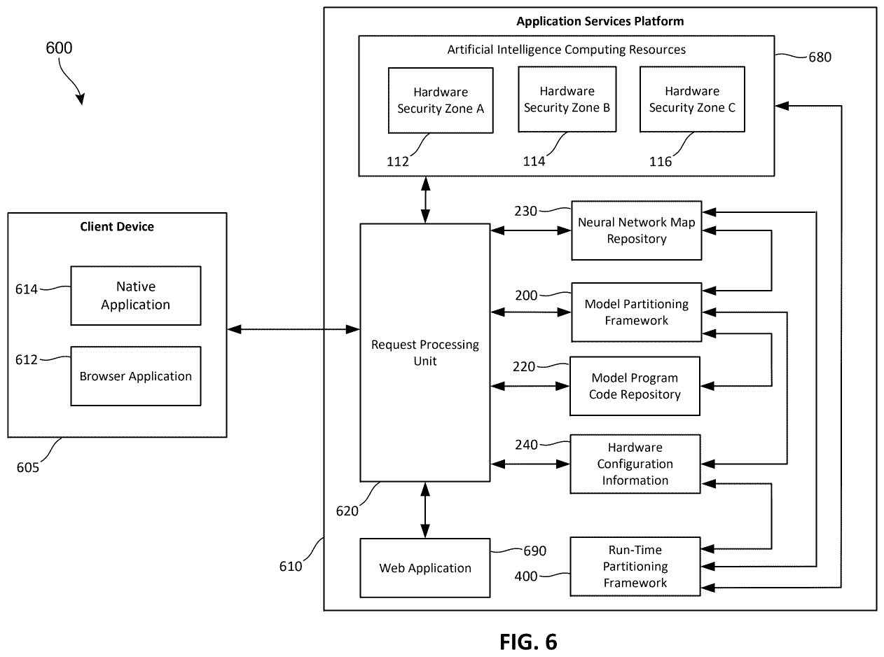

FIG. 2 is a diagram an example of a model partitioning framework 200 that can partition a neural network model according to the techniques disclosed herein. The model partitioning framework 200 can be implemented in a computing environment in which an AI model, such as the AI model 100 is developed and/or operated. An example of such a computing environment is shown in FIG. 6, which is discussed in detail below.

The model partitioning framework 200 can receive a request 201 to partition an AI model. The request can be received from an application that is configured to enable an authorized user to access the program code used to implement the neural network of an AI model, such as the AI model 100, and request that the model partitioning framework 200 automatically partition the model to be operated on specified computing hardware. The specified computing hardware can include one or more hardware security domains, as discussed above with respect to FIG. 1B.

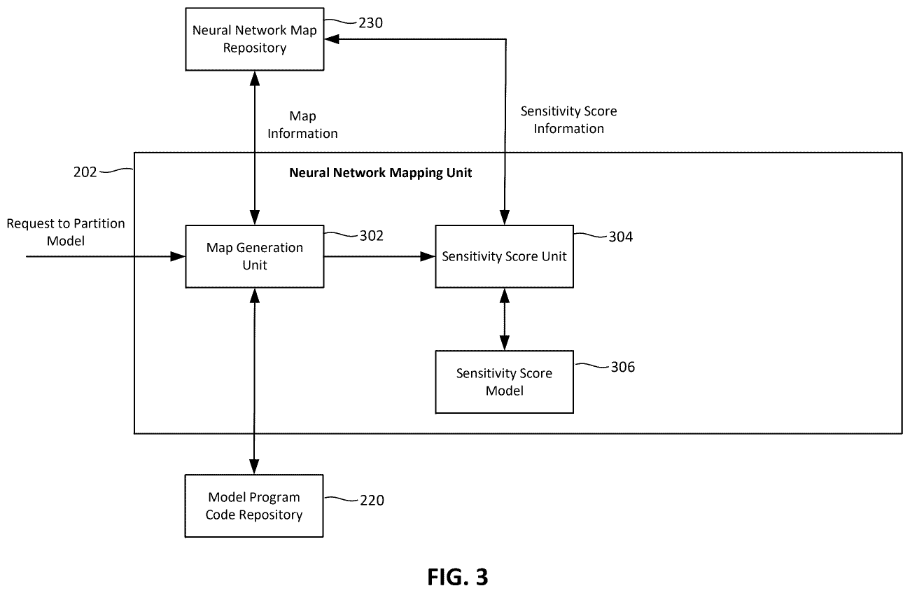

The neural network architecture mapping unit 202 receives the request 201 and accesses the model program code repository 220 to obtain the program code used to implement the AI model specified in the request 201. The neural network architecture mapping unit 202 analyzes the neural network architecture of an AI model to generate a map of layers of the neural network architecture. The neural network architecture mapping unit 202 analyzes the program code and/or configuration files used to implement the neural network to generate this map. The map includes connectivity information representing connections between the layers of the neural network architecture, and dependency information representing dependencies between the layers of the neural network architecture. The neural network architecture mapping unit 202 stores the map of the neural network in the neural network map repository 230. The neural network architecture mapping unit 202 determines security requirement for each of the layers of the neural network architecture based on the mapping information. The neural network architecture mapping unit 202 determines a layer sensitivity score for each layer that represents the security requirements of that layer. An example implementation of the neural network architecture mapping unit 202 is provided in FIG. 3.

The hardware security domain mapping unit 204 receives the map of the neural network architecture generated by the neural network architecture mapping unit 202. The hardware security domain mapping unit 204 obtains the information for the computing environments available for implementing the neural network architecture from the hardware configuration data repository 240. As discussed with respect to FIG. 1B, the computing environments can include multiple hardware security domains. Each hardware security domain includes computing hardware components available for operating portions of the AI model. The hardware information identifies security features associated with the computing hardware components for protecting sensitive data being processed by the computing hardware components from unauthorized access or tampering. Security features, as used herein refers to physical components and/or measures taken to protect the data being processed by the computing hardware of the hardware security domain from unauthorized access, tampering, and/or other security threats. Security features can also include software-based security features that implement mechanisms for protecting software and data in the hardware security domain from unauthorized access, tampering, and/or other security threats.

The hardware security domain mapping unit 204 maps neural network security requirements to the available security features of each of the hardware security domains, with specific consideration for machine learning acceleration capabilities of the computing hardware components of the hardware security domain. The hardware security domain mapping unit 204 creates a hierarchy of hardware security domains neural network operations. In a non-limiting example, the computing environment available for implementing the partitioned neural network architecture includes a first hardware security domain that includes secure machine learning accelerators, a second hardware security domain that includes hardware security modules, and third hardware security domain. The hardware security domain mapping unit 204 analyzes the ability of each hardware security domain to handle specific layer types efficiently while maintaining security guarantees.

In some implementations, the hardware security domain mapping unit 204 develops a neural network-aware cost function that considers layer-specific computational requirements, memory patterns typical of the different layer types, and cross-layer dependencies to develop the hierarchy of hardware security domains. For instance, the cost function implemented by the hardware security domain mapping unit 204 in some implementations performs the following checks for each layer-hardware pairing:
(1) Security Match Score-rather than binary “secure/not secure” decisions, the hardware security domain mapping unit 204 quantifies the precise security gap between a layer's needs and hardware capabilities. The hardware security domain mapping unit 204 calculates this as a normalized difference between the layer's sensitivity score and the hardware's security level, creating a gradient of compatibility.
(2) Layer-Type Compute Optimization-the hardware security domain mapping unit 204 analyzes the computational patterns specific to different neural network layer types (convolutional, attention, pooling, etc.) and matches them with hardware accelerators that excel at those exact operations. For instance, convolutional layers might score higher on GPU-accelerated domains, while attention mechanisms might perform better on specialized AI hardware.
(3) Neural Memory Pattern Analysis-Unlike generic memory allocation, the hardware security domain mapping unit 204 implements an approach in which the hardware security domain mapping unit 204 analyzes the unique memory access patterns of neural network operations, identifying which hardware memory architectures (unified, distributed, hierarchical) optimize performance for specific layer types based on their data locality and access frequency.
(4) Cross-Domain Transfer Intelligence-The hardware security domain mapping unit 204 models the data dependencies between layers to optimize partition boundaries, calculating exact performance penalties when dependent layers must operate across security domains.

In a specific example implementation of the hardware security domain mapping unit 204, the neural network-aware cost function for mapping a layer L to a hardware security domain H can be formulated as:

CF(L, H)=SecurityMatch(L, H)*ComputeEfficiency(L, H)*MemoryFit(L, H)/ DataTransferPenalty(L, H)

where:
SecurityMatch(L, H) evaluates how well the security features of hardware domain H satisfy the security requirements of layer L, returning a higher value when the hardware security level meets or exceeds the layer's sensitivity score without excessive overprovisioning
ComputeEfficiency(L, H) measures how efficiently the hardware domain H can execute operations specific to layer L's type (e.g., convolutional, attention, pooling), considering available accelerators and processing units
MemoryFit(L, H) assesses whether the memory characteristics of hardware domain H align with the memory access patterns and requirements of layer L
DataTransferPenalty(L, H) applies a penalty based on estimated data transfer costs if layer L is placed in domain H while its dependent layers reside in different domain.

The cost function optimizes for both security and machine learning performance metrics, including batch processing efficiency, layer activation memory requirements, and gradient computation needs during inference. The cost function can utilize the layer sensitivity score as one of the parameters of the cost function. The cost function can be used by the hardware security domain mapping unit 204 to determine whether specific layers of the neural network need to be implemented in specific hardware security domains of the computing environment. The hardware security domain mapping unit 204 can associate a hardware security domain that satisfies the minimum security requirements of each of the layers from the hierarchy of hardware security domains. This hardware-domain related information can be used when partitioning the neural network architecture into multiple domains that can be implemented in one or more of the hardware security environments.

The model partitioning unit 206 partitions the architecture of the neural network into two or more partitions based on the hardware-domain related information and the map of the neural network architecture. The model partitioning unit 206 takes into account architectural and data-driven factors to determine optimal partition points for the neural network architecture. In some implementations, the model partitioning unit 206 utilizes a cost function that incorporates factors such as, but not limited to layer sensitivity scores, memory transfer requirements between domains, the computing and security capabilities of the hardware security domains, real-time performance metrics of the computing resources of each of the hardware security domains, and information preservation measurements.

The model partitioning unit 206 implements layer-aware partitioning and neural network boundary optimization. The model partitioning unit 206 implements a partitioning algorithm that approaches partitioning of the neural network architecture as a neural network specific optimization problem. The model partitioning unit 206 identifies natural boundaries between layer groups based on the layer sensitivity scores of the layers and on architectural dependencies between layers. The model partitioning unit 206 considers layer-specific constraints, such as but not limited to maintaining layer normalization effectiveness and preserving natural gradient flow paths. The model partitioning unit 206 also considers neural architectural patterns, such as residual connections, single or multi-head attention mechanisms, and other features of layers of the neural network architecture which can be impacted by the selection of the partition boundary.

The model partitioning unit 206 also takes into account neural network boundary optimizations when determining how to partition the neural network architecture. The model partitioning unit 206 takes into account inter-layer dependences, activation tensor sizes, and layer-specific computational requirements when determining the partition boundaries. Layers with inter-dependencies may be included in the same partition to reduce the amount of data that needs to be sent to layers in another partition via a secure communication channel and to reduce overall latency introduced in the neural network architecture due to partitioning. The activation tensor sizes can also impact performance. For instance, the activation tensor size may be optimized in certain implementations to facilitate the use of tensor cores of the graphics processing unit (GPU) or to satisfy other hardware specific requirements. The model partitioning unit 206 can partition the model such that layers which can satisfy these requirements are grouped together into a partition. The model partitioning unit 206 can also determine whether to group layers together into a partition based at least in part on the computational requirements of the layers. For instance, the model partitioning unit 206 may include computationally intensive layers in different partitions, when possible, to balance the load across multiple hardware security domains. The model partitioning unit 206 may group computationally intensive layers together in other implementations where a specific hardware security domain provides computational resources that can more efficiently perform these computations while satisfying the security requirements associated with the layers. The model partitioning unit 206 also takes into consideration neural network-specific operations, such as but not limited to batch normalization and dropout, to ensure that security boundaries do not comprise model accuracy and/or training stability.

FIG. 3 is a diagram of a neural network architecture mapping unit 202 of the model partitioning framework 200 shown in FIG. 2. The neural network architecture mapping unit 202 analyzes the neural network architecture of the AI model and generates a map that includes connectivity information representing connections between the layers of the neural network architecture, and dependency information representing dependencies between the layers of the neural network architecture.

The graph analysis unit 302 accesses the program code used to implement the AI model indicated in the request 201 from the model program code repository 220. The graph analysis unit 302 utilizes graph theory to identify connections between layers of the neural network and elements of each of these layers in the program code. The neural network architecture mapping unit 202 identifies all paths through the which information can flow through the neural network architecture. The neural network architecture mapping unit 202 can identify various type of routes that sensitive information may flow through the neural network and could potentially be obtained by an unauthorized user and/or at least a portion of the original sensitive input data could be reinstructed from intermediate data obtained or generated by one or more components of the neural network architecture. The neural network architecture mapping unit 202 stores the map of the neural network in the neural network map repository 230.

The sensitivity score unit 304 determines a layer sensitivity score for each of the layers of the neural network architecture. The layer sensitivity score generated by the sensitivity score unit 304 for each layer of the neural network architecture provides representation of the security requirements of that particular layer of the neural network architecture. The security requirements for the layer provide an indication of how sensitive the data that a particular layer receives as an input, generates as intermediate data, and/or generates as an output of the layer. The model partitioning framework determines a layer sensitivity score for each of the layers of the neural network architecture. A higher layer sensitivity score indicates that the layer operates on sensitive input information and/or on data from which features of the sensitive input information can be reconstructed. A lower layer sensitivity score indicates that the layer operates on abstract feature information from which reconstruction of the features of the secure input data is computationally infeasible.

The sensitivity score unit 304 also performs layer-specific information flow analysis when generating the map of the neural network architecture. The sensitivity score unit 304 assigns a layer sensitivity score to each of the different types of layers that may be included in the neural network architecture based on the layer type. The layer scores represent how sensitive the data that each type of layer is likely to receive as an input, process, or output. The sensitivity score associated with each layer is used to determine, at least in part, the security requirements for the layer which are used when partitioning the neural network architecture into multiple partitions. In a non-limiting example, the sensitivity score unit 304 determines the sensitivity score for each layer of the neural network architecture according to the following equation:

Layer_Sensitivity=Base_Score*Position_Factor*Layer_Coefficient +Skip_Connection_Weight

where that Base_Score represents a predetermined values assigned to each of the layers of the neural network architecture which is adjusted based on the Position_Factor, Layer_Coefficient, and the Skip_Connection_Weight, the Layer_Sensitivity represents the layer sensitivity score for the layer of the neural network architecture, the Base_Score is a base score assigned to the layer based on the layer type, the Position_Factor is a coefficient used to weight the base score based on how far the layer is from the first input layer of the neural network architecture, the Layer_Coefficient is a coefficient that is assigned based on the empirical analysis of information preservation characteristics of the type of layer; and the Skip_Connection_Weight is added to the sensitivity score for layers that have direct paths to input data.

The base value serves as a starting point for determining the sensitivity score for each of the layers of the neural network architecture. The sensitivity score unit 304 adjusts the base score based on the position of the layer in the neural network architecture, the sensitivity of the type of layer, and whether the layer includes a skip connection or other architectural element that receives and/or preserves the sensitive input data and/or data from which the features of the sensitive layer information can be reconstructed.

The sensitivity score unit 304 determines the base score value based on empirical analysis of information preservation characteristics for the layer type. The sensitivity score unit 304 determines the layer coefficient based on empirical analysis of information preservation characteristics for the layer type. For instance, convolutional layers are associated with a maximum weight due to their direct feature preservation properties. To determine the value of the layer coefficient for each layer of the neural network architecture, the sensitivity score unit 304 classifies each layer of the neural network architecture by layer type. For instance, the layers of the neural network architecture can include but are not limited to convolutional layers, attention layers, pooling layers, fully connected layers, and/or other layers that perform various functions in the neural network architecture of the AI model. The types of layers that may be included depend upon the particular model architecture. Each of these layer types may have different security requirements based on the sensitivity of the data and/or the components of the model itself included in that layer. For models having complex architectures, like transformers or hybrid convolutional neural network-recurrent neural network (CNN-RNN), the sensitivity score unit 304 can utilize separate sensitivity profiles for each of these architectural components, and these architectural components can be implemented in a hardware security domain that provides an appropriate level of security in a similar manner as the layers of a neural network discussed herein. The layer coefficient assigned to each type of layer reflects the likelihood of the particular type of layer receiving sensitive input data and/or operating on data from which the sensitive input data can be reconstructed.

In a non-limiting example, the sensitivity score unit 304 associates input layers that directly process raw input data with maximum sensitivity score due to the ability of these layers to reconstruct input features. The sensitivity score unit 304 tracks the transformation from concrete feature representations to abstract feature representations through the neural network architecture. The sensitivity score unit 304 does this by adjusting the layer coefficient. The sensitivity score unit 304 associates the embedding layers with a high sensitivity score based on the encoding of identifiable features by those layers. Middle network layers are associated with progressively decreasing scores as they transform data into more abstract representations, with the reduction rate being determined by layer type and depth. Final classification layers receive the lowest sensitivity scores because these layers primarily operate on abstract feature representations. The sensitivity score unit 304 adjusts the layer coefficient accordingly for each of these layers. In a nonlimiting example, the input layers and early convolutional layers are assigned a layer coefficient in the range of 0.9 to 1.0 with the value 1.0 being the most sensitive, the embedding layers are assigned a layer coefficient in the range of 0.8 to 0.9, the middle network layers receive are assigned a layer coefficient in the range 0.3 to 0.7, and final classification layers are assigned a layer coefficient in the range of 0.1 to 0.3. These particular values are a non-limiting example, and other implementations may utilize different base sensitivity values for the layers.

The sensitivity score unit 304 determines the position factor for each of the layers of the neural network architecture. The position factor exponentially decays based on the layer depth as the layer is further from the first input layer of the neural network architecture. The exponential delay prevents sharp security boundaries while maintaining appropriate sensitivity gradients. Layers farther from the first input layer of the neural network typically are less likely to receive the sensitive input data and/or operate on data from which the sensitive input data can be reconstructed. Therefore, the layers further from the input layer are multiplied by the

The sensitivity score unit 304 determines the layer type coefficient based on the layer operation. Specific operations are more likely to involve sensitive input information than other operations that may be performed by other layers of the neural network architecture. Those layers that are more likely to perform operations on sensitive input information and/or on data from which features of the sensitive input data may be reconstructed are associated with a higher layer type coefficient. In a non-limiting example, the sensitivity score unit 304 associates a layer type coefficient of 1.0 for a convolution layer, a layer type coefficient of 0.9 for an embeddings layer, a layer type coefficient of 0.85 for an attention layer, and a layer type coefficient of 0.7 for a pooling layer.

The sensitivity score unit 304 adds the skip connection weight to the base weight multiplied by the position factor and the layer coefficient values. The sensitivity score unit 304 also identifies architectural elements that can preserve input information across layers of the neural network architecture so that the input information is available in layers that are distant from the input layers. Such architectural elements can include, but are not limited to skip connections, residual blocks, and attention mechanisms. A skip connection facilitates information flow through the neural network architecture by directly connecting the output of one layer to the input of another layer of the neural network architecture. Skip connections connect non-adjacent layers of the neural network architecture and bypass any intermediate layers. A residual block contains residual connections, which are a particular type of skip connection in which the input to the layer is added to the output of that layer. Residual connections facilitate learning residual functions in the neural networks. Residual functions determine the difference between the input and the desired output of the layer. Furthermore, attention mechanisms allow a model to focus on relevant parts of the sensitive input data. Each of these architectural elements preserve input information across layers of the neural network architecture. Other implementations can include other layers or architectural elements that carry the sensitive input data and/or data from which features of the sensitive input data may be reconstructed.

In some implementations, the sensitivity score unit 304 utilizes a sensitivity score model 306 to analyze the map of the neural network architecture of the AI model generated by the graph analysis unit 302 and determine the sensitivity scores for each of the layers of the neural architecture. The sensitivity score model 306 determines the sensitivity score for each of the layers of the model using the approach shown in the preceding equation. In some implementations, the sensitivity score model 306 determines and outputs the values for the base score, the position factor, the layer coefficient, and the skip connection weight value for each layer of the neural network, and the sensitivity scoring unit determines the sensitivity score for the layer based on the values output by the sensitivity score model 306. The sensitivity score model 306 can be implemented using a machine learning model trained to receive the map of the neural network architecture of the AI model generated by the graph analysis unit 302 and has been trained with training data that includes examples of having a variety of different layers and neural network architectures. In other implementations, the sensitivity score model 306 can be implemented as a rule-based model that analyzes the map of the neural network to determine values for the base score, the position factor, the layer coefficient, and the skip connection weight value. The sensitivity score unit 304 receives these values and determines the sensitivity score for each layer. The value of the base score, the position factor, the layer coefficient, and the skip connection weight value and/or the sensitivity score for each layer of the neural network can be stored in the neural network map repository 230 by the sensitivity score unit 304.

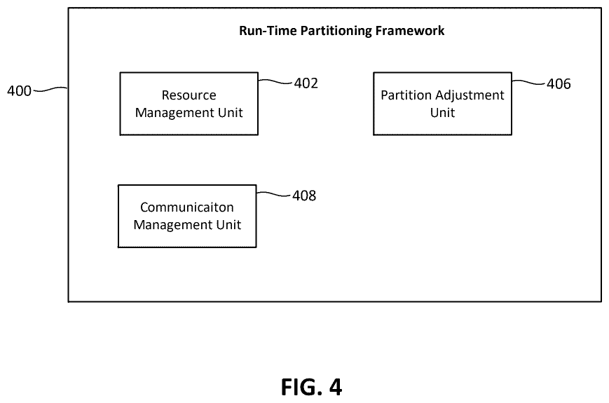

FIG. 4 is a diagram of an example run-time partitioning framework 400 according to the techniques disclosed herein. The run-time partitioning framework 400 facilitates operating the partitioned neural network architecture in the secure hardware domains identified by the model partitioning framework 200. The run-time partitioning framework 400 allocates computing resources for implementing the partitioned neural network architecture, monitors the performance of the partitioned neural network, facilitates secure communications between partitions implemented in different hardware security domains, and dynamically adjusts partitions of the neural network architecture.

The resource management unit 402 allocates computing resources for the partitioned neural network architecture in the security domains identified by the model partitioning framework 200. The model partitioning framework 200 stores the partitioning information in the neural network map repository 230 with the map of the neural network, the partition information, and the hardware security domain in which each of the partitions is to be implemented. The resource management unit 402 accesses the neural network map repository 230 to obtain the map of the neural network, the partition information, and the hardware security domain in which each of the partitions is to be implemented. The resource management unit 402 receives a request to deploy the partitioned neural network from a user interface of a model partitioning application that enables authorized users to request that the model partitioning framework 200 to partition the neural network architecture, view the partitioned neural network architecture, modify the partitioned neural network architecture, and request that the run-time partitioning framework 400 deploy the partitioned neural network architecture.

The resource management unit 402 is configured to allocate and manage computing resources in each of the security domains of the computing environment in which the partitioned neural network can be deployed. The resource management unit 402 maintains separate secure memory pools in each of the hardware security domains that can be allocated to support partitions of the partitioned neural network. The resource management unit 402 also implements scheduling algorithms that are configured to recognize the layer dependencies and computational requirements, which enables the resource management unit 402 to allocate the resources required to support each of the partitions of the partitioned neural network. The resource management unit 402 may be configured to support more than one partitioned neural network architecture. In such implementations, the resource management unit 402 can allocate memory to partitions of each of the partitioned neural network architectures that is isolated from partitions associated with the partitions of other partitioned neural network architectures. The management of the computing resources by the resource management unit 402 adds an overhead of less than fifteen percent compared with unsecured execution of the neural network architecture while ensuring that the layers of the partitioned neural network architecture that operate on sensitive input information and/or data derived from the sensitive input information from which it may be possible to extract features of the sensitive input information protect this data from unauthorized access or tampering. A technical benefit of this approach is that the cost of the computing hardware to implement a partitioned AI model can be significantly less than the cost of computing hardware required to implement the entire model in a secure hardware environment.

The resource management unit 402 is configured to manage sensitive computation timing in more secure hardware security domains so that computations on sensitive information is constant within these secure hardware security domains. The resource management unit 402 determines an estimate of how long each computation to be performed by the layers of the partitioned neural network architecture based on the map of the neural network architecture and the hardware available for executing the secure hardware domain. The resource management unit 402 can introduce a delay into computations that are estimated to be less than a target computation timing so that the computations performed in the hardware security domains have a constant time. The target computation timing can be based on an estimate of computation to be performed by the layer or partition that is estimated to take the longest amount of time relative to the other computations performed by the layer or partition. A technical benefit of this approach is that by introducing a tiny amount of latency into the computations performed by the layer or partition of the partitioned neural network architecture, an attacker would be unable to extract information about the data being processed by the various layers of the partitioned neural network architecture based on differences in time that it takes the layer or partition to complete various computations. Consequently, the security of the partitioned neural network architecture is significantly improved.

The partition adjustment unit 406 can dynamically adjust the partitions of the partitioned neural network architecture and/or adjust resource allocation to each of the partitions. The partition adjustment unit 406 monitors the utilization of computing resources by each of the partitions and determines whether moving one or more layers from a first partition in a first hardware security domain to a second partition in a second hardware security domain would reduce the overall computing resources required to implement the partitioned neural network architecture. The partition adjustment unit 406 can also determine that the computing resources required to implement the first partition in the first hardware security domain exceeds the available computing resources in the first hardware security domain and moving one or more layers of the first partition to the second partition in the second hardware security domain would reduce the resource requirements of the first partition sufficiently to be able to operate in the available computing resources. The partition adjustment unit 406 ensures that the security requirements of any layers that are moved from a first partition to a second partition are satisfied by the hardware security domain in which the second partition is implemented. In some instances, the partition adjustment unit 406 implements a new partition in a third hardware security domain and moves the layers from the first partition to the newly created third partition of the partitioned neural network architecture. This approach can be used by the partition adjustment unit 406 when the security features of the second hardware security domain does not satisfy the security requirements of the layers that were moved to the newly created third partition. The partition adjustment unit 406 can also create a new partition where there would be insufficient computing resources available in a hardware security domain associated with another existing partition. The partition adjustment unit 406 will only create a new partition if the security requirements of the layers being moved by that partition can be satisfied by the hardware security domain that would host the new partition.

The partition adjustment unit 406 can dynamically adjust the partitions of the partitioned neural network architecture based on changes to the security requirements associated with a level. The partition adjustment unit 406 monitors the inputs and output from each of the layers in each of the partitions to ensure that sensitive data and/or data from which features of the sensitive data can be reconstructed is being processed in a hardware security domain that is sufficiently secure. The partition adjustment unit 406 can move one or more layers of a partition to another partition to ensure that the security of the model remains uncompromised.

The partition adjustment unit 406 monitors information preservation ratios at security boundaries using entropy measurements and feature space analysis in some implementations. Entropy measurement in the context of AI models helps to quantify the uncertainty or randomness in the output of the model. Low entropy represents higher confidence in the output of the model, while higher entropy represents lower confidence in the output of the model. Feature space analysis utilizes a mathematical representation of the input data and may indicate that features of the sensitive input data are present in the data output by the layer. The partition adjustment unit 406 can determine a dynamic sensitivity score for a layer L using the following equation:

S(L)=α*I(X;Y|L)+β*D(L)+γ*C(L)

where I(X; Y|L) represents mutual information between input X and layer output Y, D(L) captures the layer's depth factor, and C(L) accounts for architectural connectivity patterns, and the coefficients α, β, and γ automatically tune based on network characteristics and data sensitivity.

The following depth factor, connectivity patterns, and coefficients can be determined by the partition adjustment unit 406 based on the following:
Exponential Security Decay-The depth factor D(L) is a determined using an exponential decay function that models how information transforms through neural network layers. Unlike linear approaches, this exponential model accurately reflects how sensitive information becomes increasingly abstracted in deeper layers, with the decay rate calibrated to different neural architectures.
Connectivity-Aware Security Analysis-The partition adjustment unit 406 identifies and weighs architectural elements that preserve input information (skip connections, residual blocks, attention mechanisms) differently. The partition adjustment unit 406 assigns higher weights to skip connections that bypass multiple layers, recognizing their ability to preserve sensitive input features even in deep layers of the network.
Self-Adaptive Coefficient Tuning-Rather than using fixed weights, the partition adjustment unit 406 implements a feedback mechanism that adjusts the importance of each factor based on observed effectiveness. This creates a self-improving system that adaptively balances security needs with performance constraints based on real operational data.

Specifically, the layer depth factor D(L) captures how far a layer is from the input layer in the neural network architecture. The partition adjustment unit 406 can determine the depth factor using a depth-based decay function:

D(L)=MaxDepthValue*(1-(LayerDepth/TotalNetworkDepth))

where MaxDepthValue is typically set to 1.0, LayerDepth is the number of layers between the input layer and layer L, and TotalNetworkDepth is the maximum depth of the network. This creates a declining sensitivity score as layers get further from the input, reflecting how sensitive information becomes increasingly abstracted in deeper network layers.

The connectivity factor C(L) accounts for architectural elements that might preserve sensitive information across layers. The partition adjustment unit 406 can determine the connectivity factor by examining the direct and indirect connections to the layer:

C(L)=BaseConnectivity+SkipConnectionWeight*NumSkipConnections(L)+ResidualWeight*NumResidualConnections(L)+AttentionWeight* NumAttentionMechanisms(L)

where BaseConnectivity is typically 1.0, and the weights for different connection types reflect their ability to preserve information. Skip connections receive higher weights (typically 0.3-0.5) as they directly bypass layers, while other architectural elements receive weights proportional to their information preservation capacity.

The coefficients α, β, and γ are automatically tuned through an adaptive feedback mechanism. Starting with initial values (typically α=0.6, β=0.3, γ=0.1), the partition adjustment unit 406 periodically adjusts these weights based on runtime measurements:
The partition adjustment unit 406 monitors information flow between partitions during model operation.
The partition adjustment unit 406 calculates a security effectiveness score based on how well sensitive information is contained within secure domains.
The partition adjustment unit 406 measures computational efficiency of the current partition configuration.
The partition adjustment unit 406 applies small adjustments to coefficients in the direction that improves both security and efficiency.
Coefficients are constrained to always sum to 1.0, maintaining their role as relative weights.

A technical benefit of this self-tuning approach allows the system to adapt to different model architectures and data patterns without manual reconfiguration.

The partition adjustment unit 406 can determine the dynamic sensitivity score for the layers of each partition of the partitioned neural network architecture as various types of sensitive data are processed by the AI model as discussed above. The partition adjustment unit 406 can determine whether the dynamic sensitivity score for a particular layer exceeds a threshold sensitivity score associated with the hardware security domain in which the partition has been deployed. Each hardware security domain can be associated with a threshold value that indicates the maximum level of sensitivity of a layer that can be security supported by the hardware security domain. The threshold values can be determined by the hardware security domain mapping unit 204 of the model partitioning framework 200 when the hardware configuration data is analyzed. These thresholds can be stored in the neural network map repository 230 with the map of the neural network architecture. The threshold values are determined based on the security features provided by the respective hardware security domain. The partition adjustment unit 406 determines whether another partition deployed in a different hardware security domain has sufficient computing resources available to accept the layer for which the dynamic sensitivity score exceeded the threshold. A technical benefit of this approach is that the partitions of the partitioned neural network architecture can be dynamically adjusted to enable the architecture to adapt to actual data characteristics of the data being processed by the model.

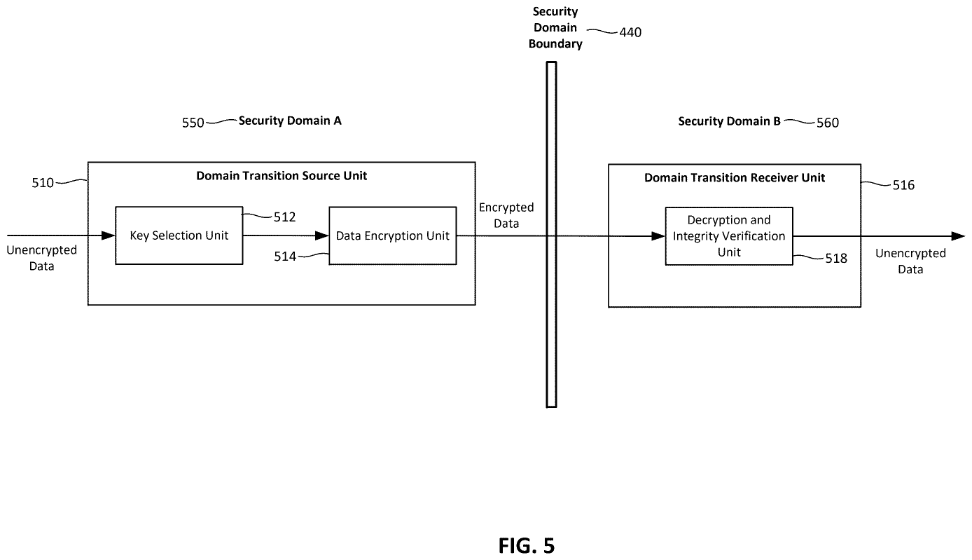

The communication management unit 408 manages the creation of secure communication channels between different partitions of the partitioned neural network architecture. The secure communication channels encrypt the data being exchanged between layers in different partitions. The secure channels implement hardware security domain-specific encryption protocols. The secure channels also implement data integrity verification and domain-specific key generation to prevent replay attacks and/or unauthorized data access. An example of such a secure communication channel being implemented is shown in FIG. 5.

FIG. 5 is a diagram of an example domain transition source unit 510 and an example domain transition receiver unit 516 for establishing a secure communication channel between partitions of a partitioned neural network. The communication management unit 408 of the run-time partitioning framework 400 shown in FIG. 4 monitors the execution of the partitions of the partitioned neural network within the various hardware security domains and can instantiate the domain transition source unit 510 in a first hardware security domain 550. The domain transition source unit 510 sends the data across a security domain boundary 440 between the first hardware security domain 550 and a second hardware security domain 560 in which a second partition of the neural network architecture is implemented. The first hardware security domain 550 and the second hardware security domain 560 may be implemented on the same computing device or server or may be implemented on separate computing devices or servers. The first hardware security domain 550 and the second hardware security domain 560 The communication management unit 408 facilitates secure communications between the two separate hardware security domains that may otherwise be isolated from each other due to security considerations.

The domain transition source unit 510 receives unencrypted data as an output from a layer of the first partition of the partitioned neural network architecture. The domain transition source unit includes a key selection unit 512 that selects an encryption key that will be used to encrypt the data to be sent to the partition operated in the second hardware security domain 560. The key selection unit 512 may implement symmetric or asymmetric key algorithms. In implementations where the key selection unit 512 implements a symmetric key algorithm, the same encryption key used to encrypt the data will be used to decrypt the data by the domain transition receiver unit 516. In implementations where the key selection unit 512 implements an asymmetric key algorithm, the key selection unit 512 selects an encryption key to be used to encrypt the data and the domain transition receiver unit 516 will use a corresponding decryption key to decrypt the encrypted data. The data encryption unit 514 encrypts the unencrypted data using the key selected by the key selection unit 512 and the encrypted data is sent to the domain transition receiver unit 516 in the second hardware security domain 560. The encrypted data output by the domain transition source unit 510 may be routed through the communication management unit 408 of the run-time partitioning framework 400 which is configured to have access to the various hardware security domains in which the partitions of the partitioned neural network architecture may be implemented.

The domain transition receiver unit 516 receives the encrypted data and the decryption and integrity verification unit 518 decrypts the data using the appropriate decryption key. The decryption and integrity verification unit 518 can also verify data integrity. The data encryption unit 514 can include a hash value, check sum, or other means for verifying data integrity at the domain transition receiver unit 516. The encryption and data integrity checks ensure that the data passing from the first hardware security domain 550 is not tampered with or altered in transit between the two hardware security domains.

FIG. 6 is a diagram of an example computing environment 600 in which the techniques for dynamically partitioning neural networks of AI models is implemented. The example computing environment 600 includes a client device 605 and an application services platform 610. The application services platform 610 may provide one or more cloud-based applications and/or provides services to support one or more web-enabled native applications on the client device 605. These applications may include but are not limited to design applications, communications platforms, visualization tools, and collaboration tools for collaboratively creating visual representations of information, and other applications for consuming and/or creating electronic content. The application services platform 610 can also provide applications for designing and partitioning neural network architectures for AI models. The client device 605 and the application services platform 610 communicate with each other over a network (not shown). The network may be a combination of one or more public and/or private networks and may be implemented at least in part by the Internet.

The model partitioning framework 200 implements the techniques for partitioning the neural network architecture of an AI model as discussed in the preceding examples. The model partitioning framework 200 accesses and analyzes program code that implements the AI model. The program code is stored in the model program code repository 220, which is implemented in a persistent memory of the application services platform 610. The model partitioning framework 200 access information about the computing resources available in the various hardware security domains available for implementing the partitioned neural network architecture. The model partitioning framework 200 stores the map of the neural network in the neural network map repository 230.

The run-time partitioning framework 400 implements the deployment and monitoring of the partitioned neural network architecture determined by the model partitioning framework 200. The run-time partitioning framework 400 facilitates inter-partition communications as well as allocation of computing resources to the partitions of the partitioned neural network architecture. The run-time partitioning framework 400 also implements dynamic adjustments to the partitioning of the model as discussed in the preceding examples.

The request processing unit 620 receives requests from an application implemented by the native application 614 of the client device 605 and/or the web application 690 of the application services platform 610. The native application 614 and/or the web application 690 provide one or more user interfaces that enables users to view, create, and/or modify electronic content. The request processing unit 620 can receive requests from the native application 614 and/or the web application 690 to create a new AI model architecture, to partition the neural network architecture of an AI model, and/or to deploy a partitioned neural network architecture. The request processing unit 620 also coordinates communication and exchange of data among components of the application services platform 610 as discussed in the examples which follow.

The AI computing resources 680 provide a computing environment that includes three hardware security domains: hardware security domain 112, hardware security domain 114, and hardware security domain 116. These hardware security domains can be used by the run-time partitioning framework to deploy partitions of a partitioned neural network architecture. Other implementations may include a different number of hardware security domains.

The client device 605 is a computing device that may be implemented as a portable electronic device, such as a mobile phone, a tablet computer, a laptop computer, a portable digital assistant device, a portable game console, and/or other such devices in some implementations. The client device 605 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 6 includes a single client device, other implementations may include a different number of client devices that utilize services provided by the application services platform 610.

The client device 605 includes a native application 614 and a browser application 612. The native application 614 is a web-enabled native application, in some implementations, that enables users to view, create, and/or modify electronic content. The web-enabled native application utilizes services provided by the application services platform 610 including but not limited to creating, viewing, and/or modifying various types of electronic content. The native application 614 provide a user interface that enables the user to design an architecture of an AI model, to partition the neural network architecture into a partitioned neural network architecture, to modify the partitioned neural network architecture, and/or deploy a partitioned neural network architecture on the AI computing resources 680. In other implementations, the browser application 612 is used for accessing and viewing web-based content provided by the application services platform 610. In such implementations, the application services platform 610 implements one or more web applications, such as the web application 690, that enables users to view, create, and/or modify electronic content. The web application 690 can provide a user interface that enables the user to design an architecture of an AI model, to partition the neural network architecture into a partitioned neural network architecture, to modify the partitioned neural network architecture, and/or deploy a partitioned neural network architecture on the AI computing resources 680. The application services platform 610 supports both web-enabled native applications and a web application in some implementations, and the users may choose which approach best suits their needs.

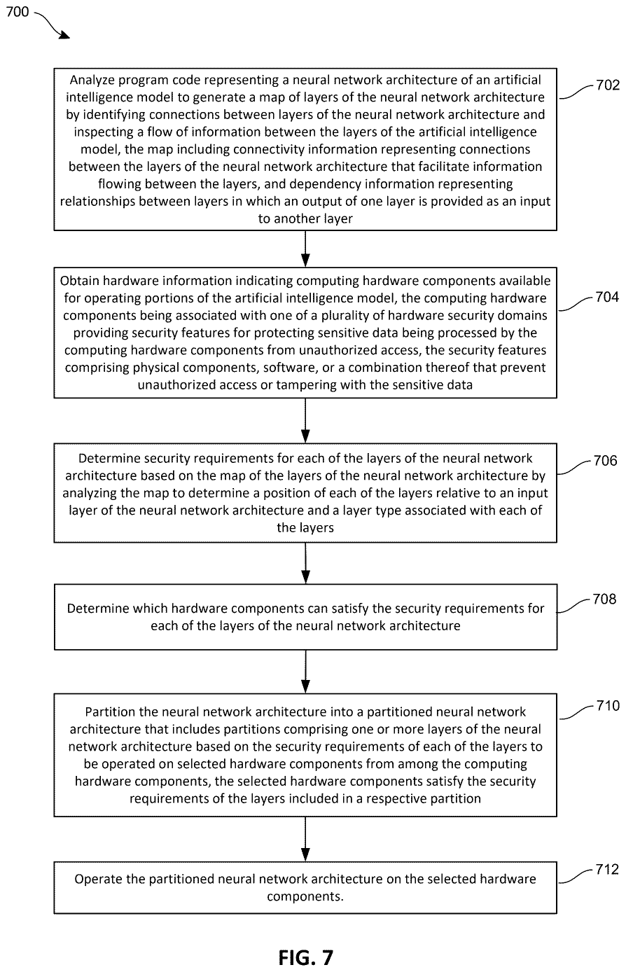

FIG. 7 is a flow chart of an example process 700 for partitioning a neural network architecture according to the techniques disclosed herein. The process 700 can be implemented by the model partitioning framework 200, the run-time partitioning framework 400, and/or the application services platform 610 discussed in the preceding examples.

The process 700 includes an operation 702 of analyzing program code representing a neural network architecture of an artificial intelligence model to generate a map of layers of the neural network architecture by identifying connections between layers of the neural network architecture and inspecting a flow of information between the layers of the artificial intelligence model. The map includes connectivity information representing connections between the layers of the neural network architecture that facilitate information flowing between the layers, and dependency information representing relationships between layers in which an output of one layer is provided as an input to another layer. The neural network architecture mapping unit 202 of the model partitioning framework 200 analyzes the program code that implements the neural network architecture of the AI model to generate the map and store the map in the neural network map repository 230. The neural network architecture mapping unit 202 can utilize a graph crawling technique in which the neural network architecture mapping unit 202 maps the flow of information through the neural network to document neural network architecture.

The process 700 includes an operation 704 of obtaining hardware information indicating computing hardware components available for operating portions of the artificial intelligence model. The computing hardware components are associated with a hardware security domain of a plurality of hardware security domains providing security features for protecting sensitive data being processed by the computing hardware components from unauthorized access. The security features comprising physical components, software, or a combination thereof that prevent unauthorized access or tampering with the sensitive data. The hardware security domain mapping unit 204 accesses the hardware configuration data repository 240 to obtain the hardware information and analyze the hardware information to determine the hardware components available for operating portions of the artificial intelligence model.

The process 700 includes an operation 706 of determining security requirements for each of the layers of the neural network architecture based on the map of the layers of the neural network architecture by analyzing the map to determine the position of each of the layers relative to an input layer of the neural network architecture and a layer type associated with each of the layers. The neural network architecture mapping unit 202 determines the security requirement of each of the layers of the neural network architecture. As discussed in the preceding examples, this security requirements can be based at least in part on the layer sensitivity score determined for each of the layers according to the techniques discussed above.

The process 700 includes an operation 708 of determining which hardware components can satisfy the security requirements for each of the layers of the neural network architecture. The hardware security domain mapping unit 204 determines which hardware components can satisfy the security requirements of each of the layers of the neural network architecture.

The process 700 includes an operation 710 of partitioning the neural network architecture into a partitioned neural network architecture that includes partitions comprising one or more layers of the neural network architecture based on the security requirements of each of the layers to be operated on selected hardware components from among the computing hardware components. The selected hardware components satisfy the security requirements of the layers included in a respective partition. The model partitioning unit 206 of the model partitioning framework 200 generates the partitioned neural network. The model partitioning unit 206 determines, based at least in part on the layer sensitivity score, whether a respective partition should be implemented in a hardware security domain that provides security features that prevent unauthorized access and/or tampering with the data and/or the model. The layer sensitivity score is indicative of how sensitive the data that the particular layer receives as an input, operates on, and/or outputs. The layer sensitivity score is higher for layers that deal with the sensitive input data and/or data from which features of the sensitive input data can be reconstructed, and the layer sensitivity score is lower for layers that deal with data comprising more abstract features from which it is less feasible to reconstruct features of the sensitive input data. The model partitioning unit 206 takes into account other factors, such as but not limited to availability of computational resources in the hardware security domains, latency associated with executing layers in these hardware security domains, computational requirements of the layers of neural network architecture, and/or dependencies and connections between the layers that would be impacted if the layers were included in separate partitions. The model partitioning unit 206 can take into account other factors in addition to or instead of these factors when partitioning the neural network architecture as discussed in the preceding examples.

The process 700 includes an operation 712 of operating the partitioned neural network architecture on the selected hardware components. The run-time partitioning framework 400 operates the partitioned neural network architecture in the hardware security domains identified by the model partitioning unit 206 of the model partitioning framework 200.

The detailed examples of systems, devices, and techniques described in connection with FIGS. 1A-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-7 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

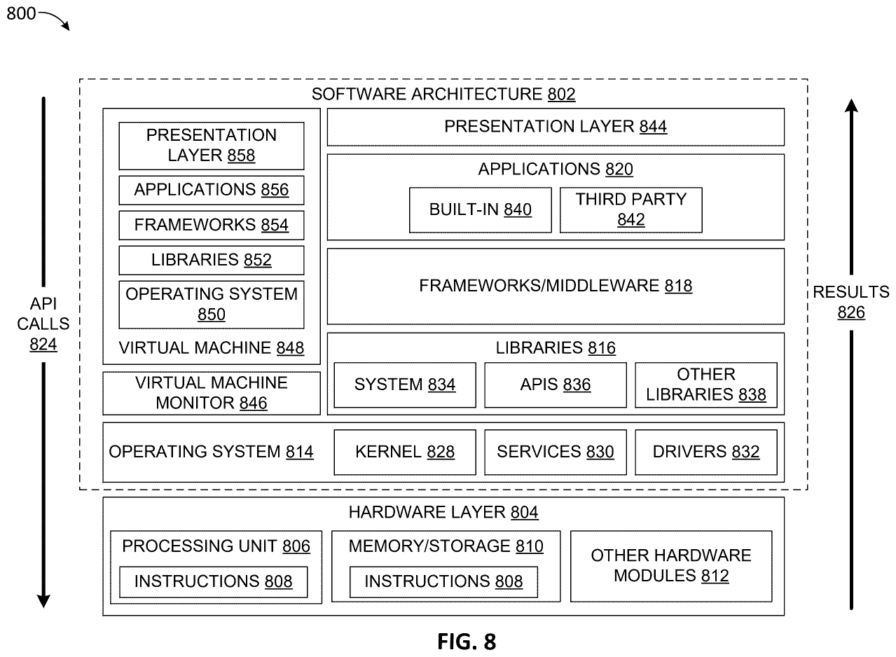

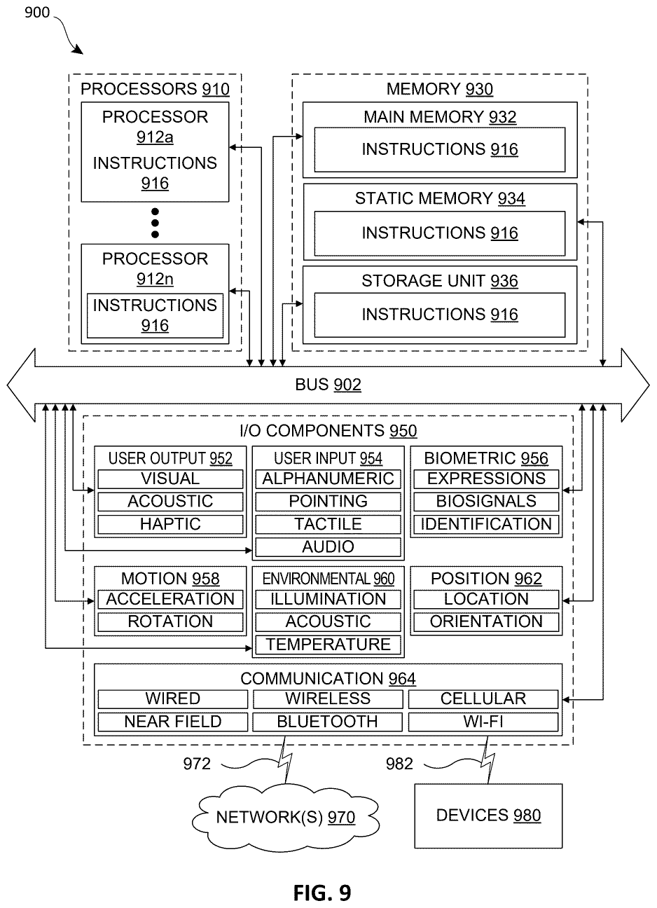

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory/storage, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks/middleware 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks/middleware 818 provide a higher-level common infrastructure that may be used by the applications 820 and/or other software modules. For example, the frameworks/middleware 818 may provide various graphic user interface (GUI) functions, high-level resource management, or high-level location services. The frameworks/middleware 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks/middleware 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory/storage 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multicore processor including cores that may execute instructions contemporaneously. Although FIG. 9 shows multiple processors, the machine 900 may include a single processor with a single core, a single processor with multiple cores (for example, a multicore processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing the connections between the layers of the neural network architecture that facilitate information flowing between the layers, and dependency information representing relationships between layers in which an output of one layer is provided as an input to another layer;
obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data;
determining security requirements for each of the layers of the neural network architecture based on the map of the layers of the neural network architecture by analyzing the map to determine a position of each of the layers relative to an input layer of the neural network architecture and a layer type associated with each of the layers;
determining which hardware components can satisfy the security requirements for each of the layers of the neural network architecture;
partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and
operating the partitioned neural network architecture on the selected hardware components.

2. The data processing system of claim 1, wherein to determine the security requirements for each of the layers of the neural network architecture based on the map of the layers of the neural network architecture, the memory further stores executable instructions that, when executed, cause the processor alone or in combination with other processors to perform operations of:
determining a layer sensitivity score associated with a respective layer of the neural network architecture based on a base score associated with the layer type of the respective layer, a position factor that decreases exponentially based on a number of layers from an input layer that the respective layer is disposed in the neural network architecture, a layer coefficient associated with information preserving characteristics of the layer type, and a connection weight factor indicating whether the respective layer includes any direct paths to sensitive input data.

3. The data processing system of claim 1, wherein to analyze the neural network architecture of the artificial intelligence model to generate the map of layers of the neural network architecture, the memory further stores executable instructions that, when executed, cause the processor alone or in combination with other processors to perform operations of:
providing each layer of the neural network architecture with input pairs; and
measuring the ability of each layer of the neural network architecture to preserve or transform sensitive information by comparing the input pairs with outputs of each layer.

4. The data processing system of claim 1, wherein to determine the security requirements for each of the layers of the neural network architecture, the memory further stores executable instructions that, when executed, cause the processor alone or in combination with other processors to perform operations of:
identifying input layers of the neural network architecture; and
associating the input layers with a maximum sensitivity score indicating that the input layers have highest security requirements from among the security requirements that can be associated with the layers of the neural network architecture.

5. The data processing system of claim 1, wherein to determine the security requirements for each of the layers of the neural network architecture, the memory further stores executable instructions that, when executed, cause the processor alone or in combination with other processors to perform operations of:
tracking a transformation of information input into the neural network architecture from concrete to abstract features.

6. The data processing system of claim 5, wherein to track the transformation of information input into the neural network architecture from concrete to abstract features, the memory further stores executable instructions that, when executed, cause the processor alone or in combination with other processors to perform operations of:
analyzing an amount of difference between an input to a respective layer of the neural network architecture and the information input into the neural network architecture.

7. The data processing system of claim 1, wherein to determine the security requirements for each of the layers of the neural network architecture, the memory further stores executable instructions that, when executed, cause the processor alone or in combination with other processors to perform operations of:
analyzing connections between layers of the layers of the neural network architecture to identify connections that preserve characteristics of input information provided as an input to the neural network architecture.

8. The data processing system of claim 1, wherein to determine the security requirements for each of the layers of the neural network architecture, the memory further stores executable instructions that, when executed, cause the processor alone or in combination with other processors to perform operations of:
identifying information preserving characteristics of the layers of the neural network architecture that preserve characteristics of input information provided as an input to the neural network architecture.

9. The data processing system of claim 1, wherein to partition the neural network architecture into a partitioned neural network architecture, the memory further stores executable instructions that, when executed, cause the processor alone or in combination with other processors to perform operations of:
implementing encrypted communications between partitions operated on separate computing hardware components that satisfy different security requirements of respective layers of the partitioned neural network architecture.

10. The data processing system of claim 1, wherein to operate the partitioned neural network architecture on the selected hardware components, the memory further stores executable instructions that, when executed, cause the processor alone or in combination with other processors to perform operations of:
monitoring information preservation ratios at security boundaries between partitions of the partitioned neural network architecture using one or more of entropy measurements or feature space analysis.

11. The data processing system of claim 10, wherein to operate the partitioned neural network architecture on the selected hardware components, the memory further stores executable instructions that, when executed, cause the processor alone or in combination with other processors to perform operations of:
determining that an information preservation ratio fell below a predetermined threshold; and
moving one or more layers of the neural network architecture from a first partition to a second partition responsive to determining that that the information preservation ratio fell below the predetermined threshold.

12. A method implemented in a data processing system for partitioning an artificial intelligence model, the method comprising:
analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing the connections between the layers of the neural network architecture that facilitate information flowing between the layers, and dependency information representing relationships between layers in which an output of one layer is provided as an input to another layer;
obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data;
determining security requirements for each of the layers of the neural network architecture based on the map of the layers of the neural network architecture by analyzing the map to determine a position of each of the layers relative to an input layer of the neural network architecture and a layer type associated with each of the layers;
determining which hardware components can satisfy the security requirements for each of the layers of the neural network architecture;
partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and
operating the partitioned neural network architecture on the selected hardware components.

13. The method of claim 12, wherein determining the security requirements for each of the layers of the neural network architecture based on the map of the layers of the neural network architecture further comprises:
determining a layer sensitivity score associated with a respective layer of the neural network architecture based on a base score associated with the layer type of the respective layer, a position factor that decreases exponentially based on a number of layers from an input layer that the respective layer is disposed in the neural network architecture, a layer coefficient associated with information preserving characteristics of the layer type, and a connection weight factor indicating whether the respective layer includes any direct paths to sensitive input data.

14. The method of claim 12, wherein determining the security requirements for each of the layers of the neural network architecture further comprising:
identifying input layers of the neural network architecture; and
associating the input layers with a maximum sensitivity score indicating that the input layers have highest security requirements from among the security requirements that can be associated with the layers of the neural network architecture.

15. The method of claim 12, wherein determining the security requirements for each of the layers of the neural network architecture further comprising:
tracking a transformation of information input into the neural network architecture from concrete to abstract features.

16. The method of claim 15, wherein tracking the transformation of information input into the neural network architecture from concrete to abstract features further comprises:
analyzing how different an input to a respective layer of the neural network architecture differs from the information input into the neural network architecture.

17. A machine-readable medium on which are stored instructions that, when executed, cause a processor of alone or in combination with other processors to perform operations of:
analyzing program code representing a neural network architecture of an artificial intelligence model to generate a map of layers of the neural network architecture by identifying connections between layers of the neural network architecture and inspecting a flow of information between the layers of the artificial intelligence model, the map including connectivity information representing the connections between the layers of the neural network architecture that facilitate information flowing between the layers, and dependency information representing relationships between layers in which an output of one layer is provided as an input to another layer;
obtaining hardware information indicating computing hardware components available for operating portions of the artificial intelligence model, the computing hardware components being associated with one of a plurality of hardware security domains providing security features for protecting sensitive data being processed by the computing hardware components from unauthorized access, the security features comprising physical components, software, or a combination thereof that prevent unauthorized access or tampering with the sensitive data;
determining security requirements for each of the layers of the neural network architecture based on the map of the layers of the neural network architecture by analyzing the map to determine a position of each of the layers relative to an input layer of the neural network architecture and a layer type associated with each of the layers;
determining which hardware components can satisfy the security requirements for each of the layers of the neural network architecture;
partitioning the neural network architecture into a partitioned neural network architecture that includes partitions comprising one or more layers of the neural network architecture based on the security requirements of each of the layers to be operated on selected hardware components from among the computing hardware components, the selected hardware components satisfy the security requirements of the layers included in a respective partition; and
operating the partitioned neural network architecture on the selected hardware components.

18. The machine-readable medium of claim 17, wherein to determine the security requirements for each of the layers of the neural network architecture based on the map of the layers of the neural network architecture, the memory further stores executable instructions that, when executed, cause the processor alone or in combination with other processors to perform operations of:
determining a layer sensitivity score associated with a respective layer of the neural network architecture based on a base score associated with the layer type of the respective layer, a position factor that decreases exponentially based on a number of layers from an input layer that the respective layer is disposed in the neural network architecture, a layer coefficient associated with information preserving characteristics of the layer type, and a connection weight factor indicating whether the respective layer includes any direct paths to sensitive input data.

19. The machine-readable medium of claim 17, wherein to determine the security requirements for each of the layers of the neural network architecture, the machine-readable medium further includes instructions configured to cause the processor alone or in combination with other processors to perform operations of: further comprising:
identifying input layers of the neural network architecture; and
associating the input layers with a maximum sensitivity score indicating that the input layers have highest security requirements from among the security requirements that can be associated with the layers of the neural network architecture.

20. The machine-readable medium of claim 17, wherein to determine the security requirements for each of the layers of the neural network architecture, the machine-readable medium further includes instructions configured to cause the processor alone or in combination with other processors to perform operations of: further comprising:
tracking a transformation of information input into the neural network architecture from concrete to abstract features.
